(19) United States
(12) Patent Application Publication
(10) Pub. No.: US 2014/0211087 A1
(43) Pub. Date: Jul. 31, 2014

(54) WIRELESS COMMUNICATION DEVICE

(71) Applicants: Chiun Mai Communication Systems, Inc., New Taipei (TW); SHENZHEN FUTAIHONG PRECISION INDUSTRY CO., LTD., Shenzhen (CN)

(72) Inventor: ZHAN LIU, Shenzhen (CN)

(73) Assignees: Chiun Mai Communication Systems, Inc., New Taipei (TW); SHENZHEN FUTAIHONG PRECISION INDUSTRY CO., LTD., Shenzhen (CN)

(21) Appl. No.: 14/014,404

(22) Filed: Aug. 30, 2013

(30) Foreign Application Priority Data
Jan. 30, 2013 (CN) 2013100354355

(51) Int. Cl. H04M 11/08

(52) U.S. Cl. CPC H04M 11/085
USPC 348/552

(57) ABSTRACT

A wireless communication device includes an antenna configured to receive a first signal and a second signal, a matching circuit connected to the antenna, a first microchip, a second microchip, a switch, and a control microchip electronically connected to the matching circuit, the first microchip and the second microchip. The switch is configured to selectively connect one of the first microchip and the second microchip to the matching circuit to receive one of the first signal and the second signal. The control microchip receives one of the first signal and the second signal from one of the first microchip and the second microchip and adjusts impedance of the matching circuit to match an input impedance of the antenna according to a signal intensity of one of the first signal and the second signal.

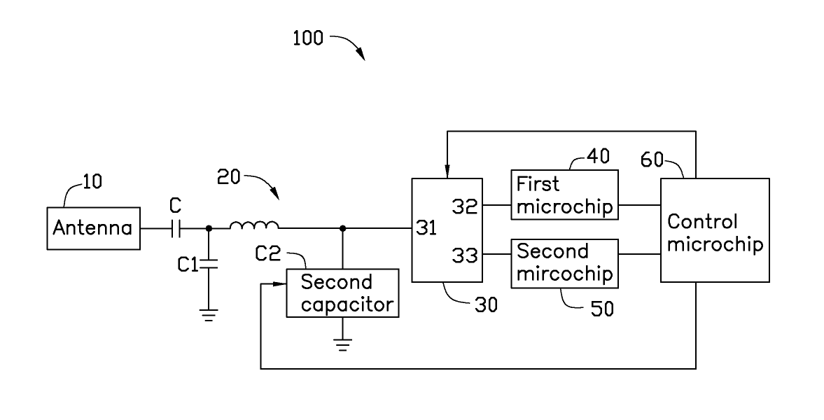

### BACKGROUND

1. Technical Field

The disclosure generally relates to wireless communication devices, and particularly to a wireless communication device having a television (TV) function.

2. Description of Related Art

Wireless communication devices such as mobile phones and personal digital assistants (PDAs) are multifunctional, and are able to perform functions of cameras, stereos, and TVs.

To realize the TV function, the wireless communication device requires a special antenna to receive TV signals and a corresponding TV microchip. However, the special antenna increases volume of the wireless communication device and also leads to a higher cost of manufacture.

Therefore, there is room for improvement within the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the disclosure.

The drawing is a block diagram of a wireless communication device, according to an exemplary embodiment of the disclosure.

### DETAILED DESCRIPTION

The drawing is a block diagram of a wireless communication device 100, according to an exemplary embodiment of the disclosure. The wireless communication device 100 can be a mobile phone, a personal digital assistant (PDA), for example.

The wireless communication device 100 includes an antenna 10, a matching circuit 20, a switch 30, a first microchip 40, a second microchip 50, and a control microchip 60.

The antenna 10 is a multiband antenna that can be used to transmit and receive a first signal at a first frequency band of about 470 MHz-806 MHz (i.e. a TV signal) and a second signal at a second frequency band of about 88 MHz-108 MHz (i.e. an FM signal). The antenna 10 transmits the first signal and the second signal to the first microchip 40 and the second microchip 50, respectively, using the matching circuit 20 and the switch 30.

The matching circuit 20 is electronically connected to the antenna 10 via an isolative capacitor C. The capacitor C is configured to protect the antenna 10 from direct current. The matching circuit 20 performs impedance matching between the microchips 40, 50 and the antenna 10 so that the antenna 10 has better radiation performance. In this exemplary embodiment, the matching circuit 20 includes an inductor L, a first capacitor C1, and a second capacitor C2. The second capacitor C2 is a variable capacitor. The inductor L is electronically connected between the isolative capacitor C and the switch 30. One end of the first capacitor C1 is electronically connected to one end of the inductor L. Another end of the first capacitor C1 is grounded. One end of the second capacitor C2 is electronically connected to another end of the inductor L. Another end of the second capacitor C2 is grounded.

The switch 30 includes an input terminal 31, a first output terminal 32, and a second output terminal 33. The input terminal 31 is electronically connected to the inductor L to receive the first signal and the second signal from the matching circuit 20. The first output terminal 32 is electronically connected to the first microchip 40 to output one of the first signal and the second signal to the first microchip 40. The second output terminal 33 is electronically connected to the second microchip 50 to output the other one of the first signal and the second signal to the second microchip 50. The switch 30 is also electronically connected to the control microchip 60. The input terminal 31 is switched between the first output terminal 32 and the second output terminal 33 under the control of the control microchip 60. In this exemplary embodiment, the first output terminal 32 outputs the first signal (i.e. the TV signal) to the first microchip 40. The second output terminal 33 outputs the second signal (i.e. the FM signal) to the second microchip 50.

The first microchip 40 and the second microchip 50 are both electronically connected to the control microchip 60. In this exemplary embodiment, the first microchip 40 may be a TV microchip, and the second microchip 50 may be an FM microchip. When the first microchip 40 is activated, for example, a TV function of the wireless communication device 100 is started by a user pressing a corresponding function key, the first microchip 40 sends a first triggering signal (such as logic 1) to the control microchip 60. When the second microchip is activated, for example, an FM function of the wireless communication device 100 is started by a user pressing a corresponding function key of the wireless communication device 100, the first microchip 40 sends a second triggering signal (such as logic 0) to the control microchip 60. Thus, the control microchip 60 controls the input terminal 31 to selectively connect to one of the first output terminal 32 and the second output terminal 33 according to the first triggering signal and the second triggering signal.

Moreover, the first microchip 40 and the second microchip 50 analyze signal intensities of the first signal and the second signal and transmit the analyzed signal intensities of the first signal and the second signal to the control microchip 60.

The control microchip 60 is also electronically connected to the second capacitor C2. A signal intensity threshold is pre-stored in the control microchip 60. The control microchip 60 compares the signal intensity of the first signal or the second signal with the signal intensity threshold. If the signal intensity of one of the first signal and the second signal is weaker than the signal intensity threshold, the control microchip 60 adjusts impedance of the matching circuit 20 by changing a capacitance of the capacitor C2 so that the matching circuit 20 enters into an optimal matching state for receiving one of the first signal and the second signal and the signal intensity of one of the first signal and the second signal is strengthened.

In use, when the first microchip 40 is activated, the first microchip 40 sends the first triggering signal to the control microchip 60. The control microchip 60 controls the input terminal 31 to electronically connect to the first output terminal 32 according to the first triggering signal so that the first signal is transmitted to the first microchip 40. The first microchip 40 analyzes the signal intensity of the first signal and sends the analyzed signal intensity of the first signal to the control microchip 60. The control microchip 60 compares the signal intensity of the first signal with the signal intensity threshold. If the signal intensity of the first signal is weaker than the signal intensity threshold, the control microchip 60 adjusts the impedance of the matching circuit 20 by changing the capacitance of the second capacitor C2 so that the matching circuit 20 enters into an optimal matching state for receiving the first signal.

Similarly, when the second microchip 50 is activated, the second microchip 50 sends the second triggering signal to the control microchip 60, and the control microchip 60 adjusts the matching circuit 20 according to the signal intensity of the second signal so that the matching circuit 20 enters into an optimal matching state for receiving the second signal.

The wireless communication device 100 receives the first signal and the second signal but uses only one antenna 10 eliminating the need for a separate special TV antenna. Moreover, the antenna 10 can obtain a better radiation performance by adjusting the impedance of the matching circuit 20 according to the signal intensities of the first signal and the second signal.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A wireless communication device, comprising:
an antenna receiving a first signal and a second signal;
a matching circuit connected to the antenna;
a first microchip;
a second microchip;
a switch configured to selectively connect one of the first microchip and the second microchip to the matching circuit to receive one of the first signal and the second signal; and
a control microchip, the control microchip electronically connected to the matching circuit, the first microchip, and the second microchip; the control microchip receiving one of the first signal and the second signal from one of the first microchip and the second microchip and adjusting impedance of the matching circuit to match an input impedance of the antenna according to a signal intensity of one of the first signal and the second signal.

2. The wireless communication device of claim 1, wherein the first microchip and the second microchip analyze signal intensities of the first signal and the second signal and transmit the analyzed signal intensities of the first signal and the second signal to the control microchip.

3. The wireless communication device of claim 2, wherein the control microchip compares the signal intensity one of the first signal and the second signal with a signal intensity threshold, and if the signal intensity one of the first signal and the second signal is weaker than the signal intensity threshold, the control microchip adjusts the impedance of the matching circuit.

4. The wireless communication device of claim 3, wherein the matching circuit comprises an inductor, a first capacitor, and a second capacitor, the second capacitor is an variable capacitor, the inductor is electronically connected between the antenna and the switch, one end of the first capacitor is electronically connected one end of the inductor, another end of the first capacitor is grounded; one end of the second capacitor is electronically connected to another end of the inductor, another end of the second capacitor is grounded, the control microchip adjusts the impedance of the matching circuit by changing a capacitance of the second capacitor.

5. The wireless communication device of claim 1, wherein the switch comprises an input terminal electronically connected to the matching circuit, a first output terminal electronically connected to the first microchip and configured to output the first signal to the first microchip, and a second output terminal electronically connected to the second microchip and configured to output the second signal to the second microchip, the control microchip controls the input terminal to selectively connect to one of the first output terminal and the second output terminal.

6. The wireless communication device of claim 1, wherein when the first microchip is activated, the first microchip sends a first triggering signal to the control microchip, and the control microchip controls the input terminal to electronically connect to the first output terminal according to the first triggering signal.

7. The wireless communication device of claim 6, wherein when the second microchip is activated, the second microchip sends a second triggering signal to the control microchip, and the control microchip controls the input terminal to electronically connect to the second output terminal according to the second triggering signal.

8. A wireless communication device, comprising:
an antenna receiving a first signal and a second signal;
a matching circuit connected to the antenna;
a first microchip;
a second microchip;
a switch configured to selectively connect one of the first microchip and the second microchip to the matching circuit to receive one of the first signal and the second signal; and
a control microchip, the control microchip electronically connected to the matching circuit, the first microchip, and the second microchip; the control microchip receiving one of the first signal and the second signal from one of the first microchip and the second microchip and adjusting impedance of the matching circuit to strengthen a signal intensity of one of the first signal and the second signal.

9. The wireless communication device of claim 8, wherein the first microchip and the second microchip analyze signal intensities of the first signal and the second signal and transmit the analyzed signal intensities of the first signal and the second signal to the control microchip.

10. The wireless communication device of claim 9, wherein the control microchip prestores a signal intensity threshold, and compares the signal intensity one of the first signal and the second signal with the signal intensity threshold, and if the signal intensity one of the first signal and the second signal is weaker than the signal intensity threshold, the control microchip adjusts the impedance of the matching circuit.

11. The wireless communication device of claim 10, wherein the matching circuit comprises an inductor, a first capacitor, and a second capacitor, the second capacitor is an variable capacitor, the inductor is electronically connected between the antenna and the switch, one end of the first capacitor is electronically connected one end of the inductor, another end of the first capacitor is grounded; one end of the second capacitor is electronically connected to another end of the inductor, another end of the second capacitor is grounded, the control microchip adjusts the impedance of the matching circuit by changing a capacitance of the second capacitor.

12. The wireless communication device of claim 8, wherein the switch comprises an input terminal electronically connected to the matching circuit, a first output terminal electronically connected to the first microchip and configured to output the first signal to the first microchip, and a second output terminal electronically connected to the second microchip and configured to output the second signal to the second microchip, the control microchip controls the input terminal to selectively connect to one of the first output terminal and the second output terminal.

13. The wireless communication device of claim 8, wherein when the first microchip is activated, the first microchip sends a first triggering signal to the control microchip, and the control microchip controls the input terminal to electronically connect to the first output terminal according to the first triggering signal.

14. The wireless communication device of claim 13, wherein when the second microchip is activated, the second microchip sends a second triggering signal to the control microchip, and the control microchip controls the input terminal to electronically connect to the second output terminal according to the second triggering signal.

15. A wireless communication device, comprising:
an antenna receiving a first signal and a second signal;
a matching circuit connected to the antenna;
a first microchip receiving the first signal and analyzing a signal intensity of the first signal;
a second microchip receiving the second signal and analyzing a signal intensity of the second signal;
a switch configured to selectively connect one of the first microchip and the second microchip to the matching circuit; and
a control microchip electronically connected to the matching circuit, the first microchip, and the second microchip;
wherein when the first microchip is triggered, the control microchip controls the switch to be connected to the first microchip, the control microchip adjusting the impedance of the matching circuit according to the signal intensity of the first signal analyzed by the first microchip; when the second microchip is triggered, the control microchip controls the switch to be connected to the second microchip, the control microchip adjusting the impedance of the matching circuit according to the signal intensity of the second signal analyzed by the second microchip.

16. The wireless communication device of claim 15, wherein the control microchip prestores a signal intensity threshold therein, and compares the signal intensity one of the first signal and the second signal with the signal intensity threshold, if the signal intensity one of the first signal and the second signal is weaker than the signal intensity threshold, the control microchip adjusts the impedance of the matching circuit.

17. The wireless communication device of claim 16, wherein the matching circuit comprises an inductor, a first capacitor, and a second capacitor, the second capacitor is an variable capacitor, the inductor is electronically connected between the antenna and the switch, one end of the first capacitor is electronically connected one end of the inductor, another end of the first capacitor is grounded; one end of the second capacitor is electronically connected to another end of the inductor, another end of the second capacitor is grounded, the control microchip adjusts the impedance of the matching circuit by changing a capacitance of the second capacitor.

18. The wireless communication device of claim 15, wherein the switch comprises an input terminal electronically connected to the matching circuit, a first output terminal electronically connected to the first microchip and configured to output the first signal to the first microchip, and a second output terminal electronically connected to the second microchip and configured to output the second signal to the second microchip, the control microchip controls the input terminal to selectively connect to one of the first output terminal and the second output terminal.
